(19) United States
(12) Patent Application Publication
(10) Pub. No.: US 2017/0063986 A1
(43) Pub. Date: Mar. 2, 2017

(54) TARGET-DRIVEN TENANT IDENTITY SYNCHRONIZATION

(71) Applicant: Microsoft Technology Licensing, LLC, Redmond, WA (US)

(72) Inventors: Burra Gopal, Bellevue, WA (US); Ramanathan Somasundaram, Bothell, WA (US); Yuriy Labunets, Redmond, WA (US)

(73) Assignee: Microsoft Technology Licensing, LLC, Redmond, WA (US)

(21) Appl. No.: 15/042,930

(22) Filed: Feb. 12, 2016

Related U.S. Application Data
(60) Provisional application No. 62/212,560, filed on Aug. 31, 2015.

(51) Int. Cl. H04L 29/08

(52) U.S. Cl. CPC H04L 67/1095; H04L 67/146

(57) ABSTRACT

Systems, components, devices, and methods for synchronizing identity are provided. A non-limiting example includes a server farm for providing network-based services. The server farm include a plurality of server computing devices, a data store operable to store data for the server farm, a service engine running on at least one of the plurality of server computing devices, and a synchronization engine running on a server computing device of the plurality of server computing devices. The service engine is configured to provide network-based services. The synchronization engine is configured to synchronize identity data from a common identity data repository to the data store and to manage synchronization state data stored in the data store.

### BACKGROUND

Network-based services may be provided by multiple server farms. Further, the network-based services may support multiple tenants. Typically, each tenant (e.g., a group or organization) has its own instance of the network-based service and is isolated from other tenants (e.g., each tenant may have its own data, users, and configuration, which are typically unaffected by and inaccessible to other tenants). The tenants may be associated with various identity data relating to users or other entities associated with the tenant such as user account names, authentication and privilege/permission information, and biographical information (e.g., name, contact information, office location, job title, department, supervisor). This tenant identity data may be stored in a common repository that is separate from any particular server farm.

Generally, a server farm maintains a copy of at least some of the identity data for the tenants with which the server farm is associated. A separate server that is independent of the server farm may be used as a broker to synchronize the tenant identity data between the repository and the server farm. It may be difficult to properly resume synchronization of the tenant identity data if either the broker or a server farm unexpectedly becomes unavailable (e.g., due to a system crash or network outage). Additionally, a separate broker may not be able to scale as the number of tenants increases and the amount of tenant identity data increases. Thus, multiple separate brokers may be needed, which can increase the administrative burden of synchronizing the data (e.g., by requiring additional machines to act as brokers, by requiring maintenance of a mapping between brokers and server farms).

### SUMMARY

Non-limiting examples of the present disclosure describe synchronization of data from a repository to a server farm. In an example, the server farm includes a synchronization engine running on a server computing device of the server farm. The synchronization engine synchronizes identity data from a common identity data repository to a data store. Other examples are also described.

In summary, this disclosure generally relates to systems and methods for synchronizing data to a server farm. In some examples, the server farm includes a plurality of server computing devices, a data store operable to store data for the server farm, a service engine running on at least one of the plurality of server computing devices, and a synchronization engine running on a server computing device of the plurality of server computing devices. The service engine is configured to provide network-based services. The synchronization engine is configured to synchronize identity data from a common identity data repository to the data store and to manage synchronization state data stored in the data store.

This summary is provided to introduce, in a simplified form, a selection of concepts that are further described below in the detailed description. This summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates a network-based services management system including server farms that include a target-driven identity synchronization engine.

FIG. 2 illustrates an aspect of the network-based services manager of FIG. 1.

FIG. 3 illustrates example aspects of the target-driven identity synchronization engine and the synchronization data of FIG. 1.

FIG. 4 illustrates an exemplary method for performing a synchronization operation performed by some aspects of the synchronization engine of FIG. 1.

FIG. 5 illustrates an exemplary method for determining whether to perform a synchronization operation performed by some aspects of the synchronization engine of FIG. 1.

FIG. 6 illustrates an exemplary method for recovering a server farm and restoring synchronization performed with some aspects of the system of FIG. 1.

FIG. 7 illustrates a computer architecture for a computer used in various aspects of the system of FIG. 1.

### DETAILED DESCRIPTION

The present disclosure describes synchronizing data from an external repository to data stores within server farms. The server farms may be globally distributed and may provide network-based service for many tenants (e.g., groups or organizations using the network-based services provided by the server farm). The external repository may be a global repository of data that is used by a large number of server farms.

For example, the data may include identity data related to one or more tenants of the server farms. An example of the identity information is information about users and user accounts associated with a particular tenant. The identity data is initially synchronized to a server farm when the tenant is first allocated to the server farm. The initial synchronization may comprise copying the identity data from the external repository to the server farm. Thereafter, synchronizing the data comprises, for example, adding or removing users and updating information and permissions associated with existing users.

An example server farm includes a plurality of servers, at least one of which includes a synchronization engine. The synchronization engine controls the synchronization of data, such as identity data, from the external repository to the data stores of the server farms. In some aspects, all of the data used to perform the synchronization operations is managed by the synchronization engine and is stored within the data stores of the server farms. Because the synchronization engine and the synchronization data is part of the server farm, coordinating synchronization operations and recovering from errors are simplified. For example, synchronization operations can be based on the state of the server farm and stop occurring in the event that a server farm is off line. During a recovery operation (e.g., after a disaster), the tenant data and synchronization data can be recovered concurrently and from the same backup data. In this manner, the recovered synchronization data can be used to resume appropriate synchronization operations for the recovered tenant data (e.g., to receive updates to the tenant data occurring since the backup data was captured).

In aspects, the synchronization engine performs synchronization operations on a regular schedule. Additionally or alternatively, the synchronization engine performs synchronization operations based on operating conditions of the server farm. Example operating conditions include the state of the server farm, the workload of the server farm, and the available resources of the server farm. For example, when a server farm is off line (e.g., down for maintenance), the synchronization engine does not perform synchronization operations. As another example, when it is determined that the server farm has a heavy workload, the synchronization engine may not perform synchronization operations or throttles the synchronization operations. Throttling a synchronization operation may comprise performing the synchronization operation more slowly (e.g., receiving identity data at a slower rate) than it would otherwise (or in another manner that uses fewer resources of the server farm). The synchronization engine may also monitor the workload of the server farm to determine when to increase the speed of the synchronization operation (e.g., when to stop throttling the synchronization operation).

The synchronization engine may determine the state and workload of the server farm based on information stored in a data store of the server farm. For example, the data store may include a database containing a record with a field indicating the current state of the server farm. The data store may include a database containing tables of currently executing job, queued jobs, and scheduled jobs, which may all be queried to determine the workload of the server farm. Some aspects prioritize jobs (e.g., the tables may also include priority values for the jobs) and determining the workload of the server farm may comprise determining the resources required to perform the currently executing, queued, and scheduled jobs that have a higher priority than the synchronization operation.

In some aspects, the synchronization engine determines when to add additional tenants to a server farm. The determination of whether to add new tenants may be based on the current utilization of the server farm and the resources remaining on the server farm. The synchronization engine may calculate a weight value that corresponds to whether the associated server farm can currently provide network-based services for additional tenants. In some embodiments, the weight value is set by a user such as an administrator via a settings file or a user interface. In some aspects, the weight value may be a Boolean value that indicates that the server farm currently can or cannot provide network-based services to another tenant. The synchronization engine may then evaluate the weight before accepting any new tenants (e.g., before beginning a new tenant assignment/synchronization job in a job queue shared by multiple server farms). If the synchronization engine does not accept the new tenant job, another server farm may accept instead. In some aspects, if multiple server farms are currently capable of accepting a new tenant, the server farm associated with the first synchronization engine to update a job record associated with the new tenant job (e.g., to indicate the job is taken, in process, or completed) will end up providing services to the new tenant.

Beneficially, aspects of the disclosed synchronization engine eliminate the need for an external broker to perform the synchronization operations. For example, the complexity and potential errors associated with tracking the state of the server farm in the external broker may be eliminated. Because the synchronization process is managed internally by the server farm, the state of the server farm can directly affect whether the synchronization operations can be performed (e.g., when the server farm is offline, the synchronization engine is also offline). By eliminating the need for an external broker, fewer computing resources are needed to perform the synchronization operations, which means synchronization may be performed using less power, network traffic, and storage than would be required when an external broker is used. Another example benefit is the elimination of the complexity associated with maintaining three copies of the data that is being synchronized. For example, the broker may store a local copy of a portion of the data from the external repository. This local copy may become out of sync with the data store in the server farm, such as when the server farm is down for maintenance. Resynchronizing the broker with the data store in the server farm may require manual intervention and may add to the complexity of bringing a server farm back on line after a maintenance operation. Further, the synchronization engines within the server farms may scale better as the number of server farms increases. In contrast, an external broker may not be able to scale as the number of server farms associated with the external repository increases. In other words, the time required by the broker to synchronize each of the server farms may result in the data on the server farms becoming out of date. Finally, in some aspects, the disclosed synchronization engines may eliminate a potential single point of failure for multiple server farms. For example, the external broker may be a single point of failure that when taken off line (e.g., due to a system failure or to perform maintenance, etc.) prevents all of the associated server farms from being updated. In contrast, the disclosed synchronization engine operates on the servers of the associated server farm and, in some aspects, is running any time the server farm is running. Accordingly, the disclosed synchronization engine eliminates the single point of failure associated with some external brokers and thus prevents the data in the server farms from becoming out-of-date due to the broker being off line.

When synchronization is performed by an external broker, synchronization partitions may be used to define data or tenants that should be synchronized at the same time. These defined synchronization partitions may correspond to a portion of a server farm (e.g., particular tenants), portions of multiple server farms, or one or more entire server farms. For example, a broker may synchronize one or more of the defined synchronization partitions with tenant identity data from the external repository. In contrast, when the synchronization engine operates within a server farm, the synchronization partitions are defined as the server farms (e.g., there is no need for a synchronization partition that is distinct from the server farm). In this manner, the synchronization operations are related to the architecture or topology of the server farms (rather than separate synchronization partitions). The synchronization operations proceed based on the state of the server farm, rather than the states of potentially multiple server farms (which would be the case when a synchronization partition spanned multiple server farms). By treating the server farm as the synchronization partition (e.g., establishing a one-to-one relationship between synchronization partitions and server farms), the possibility that some of the server farms associated with a synchronization partition are up and running while others are down is eliminated.

When converting server farms that were previously synchronized using an external broker, a process may be used to establish a one-to-one relationship between existing synchronization partitions and server farms. If an existing synchronization partition currently spans multiple server farms, multiple synchronization partitions may be generated to correspond to each of the server farms associated with the existing synchronization partition. Further, in some aspects, if a single tenant spans multiple server farms, the tenant may be moved to one of the server farms. However, in other aspects, a single tenant may continue to be associated with multiple server farms. In these aspects, the identity data associated with the tenant may be synchronized to each of the server farms. In some aspects, to move a synchronization partition from multiple server farms to a single server farm, one of the server farms is designated as a primary server farm for new tenants. Any new tenants assigned to the synchronization partition are assigned to the primary server farm (at least during the time period during which the one-to-one relationship is being established). Designating a primary server farm may simplify the process of managing which server farm within the synchronization partition receives new tenants while tenants are being migrated and synchronization partitions are being reconfigured.

Because the synchronization partitions have a one-to-one relationship with server farms, the synchronization operations relate to the server farm topology itself (e.g., virtual and physical machines, DNS end points, etc.), which changes infrequently. In contrast, when synchronization partitions are distinct from the server farms (e.g., when an external broker is used), the synchronization operations are related to the synchronization state (e.g., running, blocked, in-maintenance, etc.) of multiple server farms, which may change frequently.

When the synchronization engine is part of the server farm, the server farm may manage all resources for a tenant (e.g., tenant-to-database mapping, domain name server (DNS) updates, telemetry (use monitoring), etc.) completely inside the server farm without using an external or central broker to store or track a state of the server farm. Additionally, the server farm may manage weight values (that determine new tenant load) completely based on the state of the server farm and the load it is currently handling, in an automated manner (i.e., the weight associated with the server farm for new tenants now depends on the state of the server farm).

Synchronization operations may be performed as idempotent, restartable processes by managing all synchronization state within the server farm. In this manner, the server farm becomes the unit of recovery (e.g., if a data store for a server farm is rolled back, the synchronization state information for the server farm is also rolled back because it is stored in the data store). The synchronization operations may then resume after recovery of the server farm using the synchronization state corresponding to the recovered data. The synchronization process is not dependent on any other server farm or any centrally/externally managed state for that server farm to come back on line after a disaster. Beneficially, this makes disaster recovery simpler and more automatic.

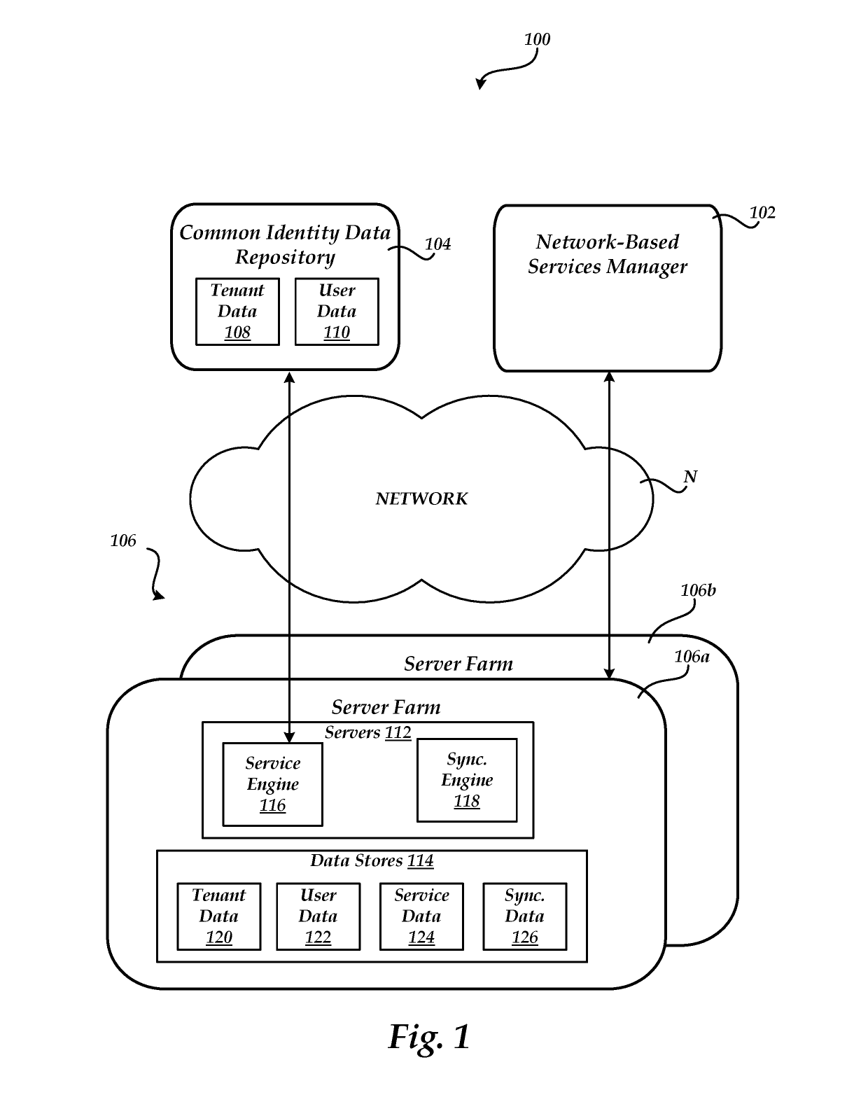

FIG. 1 illustrates a network-based services management system 100 including server farms 106 that include a target-driven identity synchronization engine 118. The system 100 includes a network-based services manager 102, a common identity data repository 104, and the server farms 106. Also shown in FIG. 1 is network N, which may be any type of network including a local area network (LAN), a wide area network (WAN), or the Internet.

The network-based services manager 102 comprises at least one server computing device that can connect over a network to the server farms 106. The network-based services manager 102 operates to deploy, configure, and manage the server farms 106. The network-based services manager 102 may be a cloud-based service (e.g., accessed by tenants over the Internet) or may be located in an on-premises data center. Other aspects are possible as well. In some aspects, the server farms 106 are organized into server farm networks, wherein the server farm networks each comprise one or more of the server farms 106. The server farms within a network may be associated with a particular geographical region and may together operate to serve tenants located in (or requiring network-based services in) a particular geographical location. For example, different server farm networks may be associated with North America, Europe, Asia, etc. The network-based services manager 102 may be configured to manage server farms from a single server farm network or from multiple server farm networks.

The common identity data repository 104 comprises at least one server computing device and operates to manage identity data. In some aspects, the common identity data repository 104 manages tenant identity data, including tenant data 108 and user data 110. Examples of the tenant data 108 include organization name. Examples of data included in some aspects of the user data 110 include user account names (e.g., user IDs), user authentication information (e.g., passwords, security keys, or other forms of authentication data), user permission/privilege information, biographical information (e.g., name, contact information, office location, job title, department, supervisor), and data relating users to tenants. In some aspects, the common identity data repository 104 comprises a database such as a relational database. Example relational databases included the databases provided by the SQL SERVER® database management system from Microsoft Corporation of Redmond, Wash. Alternatively, the common identity data repository 104 comprises a directory service. An example directory service is the ACTIVE DIRECTORY® directory service also from Microsoft Corporation. The common identity data repository 104 may also comprise a file system that stores files (in any appropriate format) containing the tenant identity data. The common identity data repository 104 may comprise multiple redundant server computing devices (or groups of server computing devices) located in a plurality of locations throughout the world. In some aspects, the common identity data repository 104 operates using one or more virtual machines provided by one or more server computing devices.

The server farms 106 operate to provide network-based services for tenants. Non-limiting examples of network-based services include the SHAREPOINT® team collaboration services, LYNC® messaging services, EXCHANGE® messaging and collaboration services, and DYNAMICS® business services all from Microsoft Corporation of Redmond, Wash. Additional examples of network-based services include the GOOGLE FOR WORK enterprise services from Google Inc. of Mountain View, Calif. and SALES CLOUD from Salesforce.com of San Francisco, Calif. The server farms 106 can provide other network-based services as well. The server farms 106 may be located anywhere, including in proximity to the network-based services manager 102 or distributed in various locations throughout the world. In the aspect illustrated in FIG. 1, the server farms 106 include server farm 106a and server farm 106b. Other aspects include additional server farms.

The server farms 106 comprise servers 112 and data stores 114. The servers 112 may comprise virtual machines, physical machines, or both. The servers 112 perform a variety of functions or services for the server farms 106. The servers 112 may all have the same configuration or may have a variety of configurations. For example, some of the servers that are configured to perform tasks in response to user requests may include more computing power, while other servers may be configured with more storage capabilities.

The server farms 106 may be configured as dedicated farms for a single tenant or as shared farms for use by multiple tenants. The server farms 106 may include a changing number of physical/virtual machines and a configuration of those physical/virtual machines that can change after deployment. Generally, a server farm may continue to grow, shrink, or be reconfigured over time. For example, a server farm may start out with ten servers and later expand to one hundred or more servers. The machines within a server farm may be assigned a class or type. For example, some of the servers may be compute machines (e.g., to be used for Web front ends and application servers) and other machines may be storage machines that are provisioned with more storage than compute machines.

According to some aspects, the server farms 106 are assigned weights that correspond to whether new tenants should be assigned to a server farm or the proportion of new tenant data that should be directed to or allocated to the server farms. In some aspects, the server farms 106 each operate to determine their own weight values based on one or more of the following factors: capacity to handle requests, storage capacity for tenant identity data or other data (such as service-specific objects, data, or documents), current load (e.g., number and complexity of requests the server farm is currently handling), and operational status (e.g., whether the server farm is running, blocked, in maintenance, etc.).

A server farm may comprise a cluster of networked, load-balanced machines that expose one or more virtual IP addresses to the outside world and can route traffic to the machines within the server farm. The machines in the server farm are generally tightly coupled and have minimum latencies (e.g., <1 ms ping latency).

Server farms comprise groupings of machines used to coordinate network-based services that are provided by applications. For example, a server farm may be deployed for a content management application, such as the Microsoft SHAREPOINT® content management application. In some aspects, the set of machines in each of the server farms 106 provides web service and application server functions together. In some aspects, the machines inside the farm run the same build of an application (e.g., the SHAREPOINT® application) and share a common configuration database to serve one or more tenants as well as one or more site collections associated with those tenants.

Farms can contain heterogeneous sets of virtual machines that perform various roles. In some aspects, the network-based services manager 102 maintains one or more goals or targets within data store 168 which correspond to target numbers of machines of each role within a farm. Some roles include content front end, content central admin, content timer service, federated central admin, federated application server, etc. For example, content farms are the basic SHAREPOINT® farms that handle incoming customer requests. Federated services farms contain SHAREPOINT® services that can operate across farms such as search and profile storage. Farms may be used for hosting large capacity public Internet sites. The server farms may contain one or more Active Directory® servers. The network-based services manager 102 automatically deploys and/or decommissions virtual machines in the server farms 106 to help in meeting the defined targets and goals. These goals may be automatically and/or manually configured. For example, the goals may change to respond to changes in activity and capacity needs.

The server farms may be arranged in networks or other groupings of the server farms. The server farms in a particular network may share a common purpose such as to provide network-based services to a particular geographic region.

The servers 112 include a service engine 116 and the target-driven identity synchronization engine 118. The service engine 116 and the target-driven identity synchronization engine 118 operate as applications or services on one or more machines (e.g., virtual machines or physical machines) of the servers 112. In at least some aspects, the service engine 116 and the target-driven identity synchronization engine 118 operate on the same one or more machines of the servers 112. In this manner, the service engine 116 and the target-driven identity synchronization engine 118 may share resources and lessen the total demand for computing resources such as virtual machines or physical machines.

The service engine 116 performs any operations necessary to provide the network-based services. For example, the service engine 116 may provide interfaces for users or machines to access the services. Additionally, the service engine 116 may manage some of the data in the data stores 114. The service engine 116 may also perform scheduled tasks (e.g., running scripts based on a timer) as requested by users, including administrators.

The target-driven identity synchronization engine 118 operates to synchronize tenant identity data in the common identity data repository 104 with the data stores 114 (e.g., the tenant data 120 and the user data 122). The target-driven identity synchronization engine 118 is driven by the server farm of which it is a part. In this manner, the target-driven identity synchronization engine 118 maintains the identity data in the server farm 106a based on the needs of the server farm. Beneficially, because the target-driven identity synchronization engine 118 is part of the server farm 106a, the target-driven identity synchronization engine 118 may be affected by the state of the server farm 106a. Thus when the server farm 106a is running, the target-driven identity synchronization engine 118 is also running.

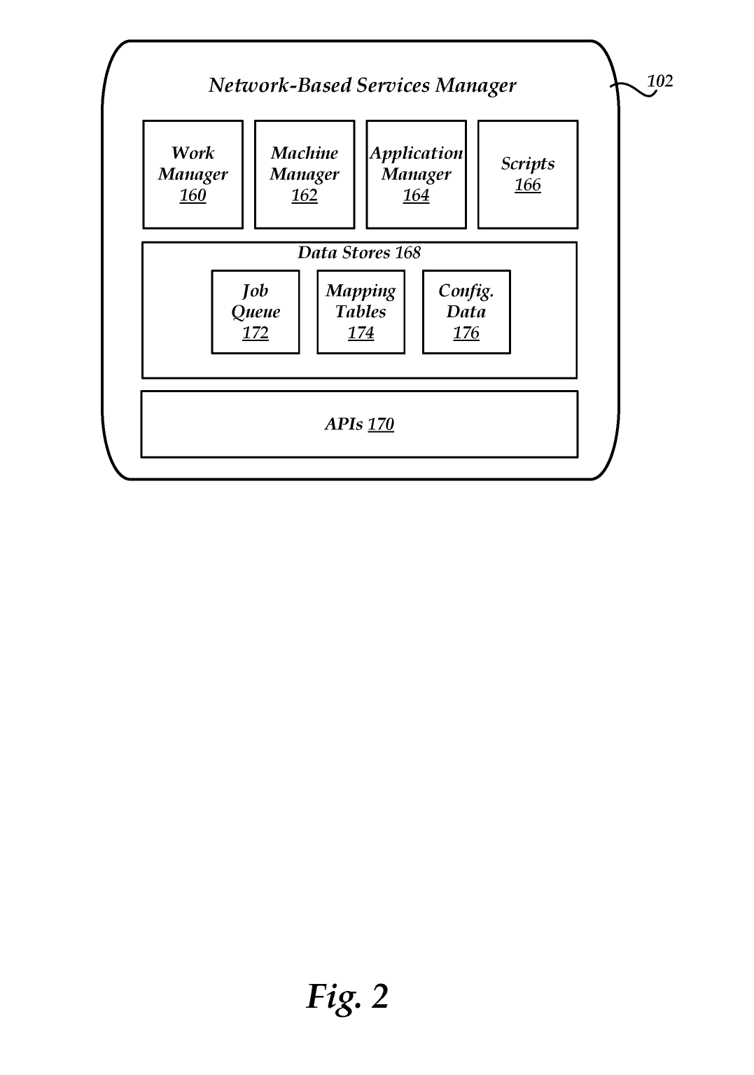

FIG. 2 illustrates an aspect of the network-based services manager 102. Generally, the network-based services manager 102 assists in deploying and managing networks for a network-based service, such as an online content management service or team collaboration service. The network-based services manager 102 is a central coordination service that receives requests to perform operations relating to configuring, updating, and performing jobs in the server farms 106. For example, the network-based services manager 102 may be called to manage assets (e.g., machines, tenants, services, etc.) within one or more of the server farms. The management of the assets may comprise deploying machines, updating machines, removing machines, performing configuration changes on servers, and deploying or updating virtual machines, as well as performing other jobs relating to the management of assets. In at least some aspects, the network-based services manager 102 is configured to receive requests through an idempotent and asynchronous application programming interface 170 that does not rely on having a reliable network and can tolerate intermittent network failures.

As illustrated, the network-based services manager 102 comprises a work manager 160, a machine manager 162, an application manager 164, scripts 166, a repository, such as data stores 168 (e.g., databases), and application programming interfaces (APIs) 170. In some aspects, the data stores 168 store a job queue 172, mapping tables 174, and configuration data 176. Other aspects of the network-based services manager 102 include additional, fewer, or different components.

The work manager 160 manages the execution of jobs and enables scheduling and retrying of longer running jobs. For example, the jobs may relate to deploying or configuring the server farms 106 or associating tenants with the server farms 106. In some aspects, the work manager 160 starts jobs stored in the job queue 172 and keeps track of running jobs. When a predetermined time has elapsed, the work manager 160 may automatically cancel a running job and perform some further processing relating to the job. According to one aspect, the jobs in the job queue 172 are executed by the work manager 160 by invoking one or more of the scripts 166. For example, a scripting language such as PowerShell® from Microsoft Corporation of Redmond, Wash. may be used to program the scripts to perform jobs that are executed by the work manager 160. In some aspect, each job or script is run as a new process. While executing each job script as a new process may have a fairly high CPU overhead, doing so increases scalability and helps to ensure a clean environment for each job or script execution as well as full cleanup when the script is completed.

Additionally or alternatively, the job queue 172 may also store jobs that are to be performed by the target-driven identity synchronization engine 118 of one of the server farms 106. These jobs may be generated by the work manager 160 and operate to allocate a new tenant to a particular server farm or network of server farms. For example, the work manager 160 may generate a job in the job queue 172 to allocate a new tenant to a network of server farms that are configured to provide services to a geographic location requested by the tenant. Thereafter, the target-driven identity synchronization engine 118 of one of the server farms 106 from the network of server farms may begin to perform the allocation job and may update the job queue 172 to indicate that the job is being performed. In some aspects, the server farms 106 operate independently of each other and the first server farm 106 to claim the new tenant will be associated with the new tenant and will perform a synchronization operation to receive identity data associated with the tenant. As described in greater detail below, the target-driven identity synchronization engine 118 may evaluate various factors associated with its corresponding server farm before claiming a new tenant, such as the operating conditions, current and scheduled workload, and available capacity to serve additional tenants (which may be represented as a weight value).

The machine manager 162 manages machines (whether physical or virtual) in the server farms (e.g., the servers 112). Generally, the machine manager 162 uses or configures server farms, physical machines, virtual machines (VMs), VM images (VHDs), and the like. In some aspects, the machine manager 162 does not have a strong binding to the specific services running within the server farms 106 but instead keeps track of the various components in the server farms 106 in terms of “roles.” For example, the machine manager 162 could be requested through API 170 to deploy a VM of role “Foo” with version 12.34.56.78 on the server farm 106a. In response to a request to the network-based services manager 102, machine manager 162 locates a suitable physical machine that is associated with (or can become associated with) the identified server farm 106a creates or configures a VM according to the VHD associated with requested VM's role. For example, the physical machine may be configured using a VHD for the role Foo with version 12.34.56.78 that may be stored within a data store, such as data store 168. The images may also be stored in other locations, such as a local data share for one or more of the server farms 106. Scripts may be run to perform the installation of the VHD on the physical machine as well as for performing any post-deployment configuration. In some aspects, the machine manager 162 stores the configuration of the severs of the server farms 106 as part of the configuration data 176. For example, the machine manager 162 may keep track of a VM's role, a state of the VM (e.g., Provisioning, Running, Stopped, Failed), a version, and an identifier of the server farm with which the VM is associated.

The application manager 164 operates to provide services and perform configuration that is specific to a particular application that provides a network-based service on one or more of the server farms. The application manager 164 generates and stores application-specific information relating to a specific network-based service provided by one or more of the server farms 106. For example, the application-specific information may relate to Microsoft SHAREPOINT®. As such, the application manager 164 is configured to manage SHAREPOINT® tenants, site collections, and the like.

The scripts 166, when executed by a server, operate to perform work either locally for the network-based services manager 102 or remotely on one or more of the server farms 106. One or more of the scripts 166 may also be stored in other locations. For example, scripts to be performed on one of the server farms 106 may be stored locally within that server farm. The scripts may be used for many different purposes. For example, the scripts may be used in performing configurations of machines in one or more of the server farms, changing settings on previously configured machines, adding a new VM, adding a new database, moving data from one machine to another, adding a tenant to a server farm, moving a tenant from one server farm to another, and the like. According to one aspect, the scripts are written in the PowerShell® scripting language from Microsoft Corporation of Redmond, Wash. Other programming languages or implementations may be used as well. For example, a compiled and/or late-bound programming language may be used to implement the functionality. A late-bound programming language is a programming language in which multiple versions of underlying code-bases can be targeted without necessarily linking to different interface DLLs. Using PowerShell® language scripts allows a process to be started locally by the network-based services manager 102 that may in turn start a process on a remote machine (i.e., a machine in one of the server farms 106). Other techniques may also be used to start a process on a remote machine, such as secure shell (SSH) and the like.

The APIs 170 may be configured to support a massively scalable global service. For example, the APIs may assume that any network request might fail and/or hang in transit. In some aspects, the APIs include web services APIs (e.g., APIs that can be accessed using the hypertext transport protocol). Calls to the network-based services manager 102 are configured to be idempotent. In other words, the same call may be made to the network-based services manager 102 multiple times (as long as the parameters are identical) without changing the outcome.

In some aspects, the network-based services manager 102 maintains records to keep track of current requests to a service. For example, the network-based services manager 102 updates records in the data stores 168 and if necessary adds or schedules a “job” in the job queue 172 to perform a more lengthy activity later.

Network-based services manager 102 keeps track of images (such as VHDs) that are the templates used to deploy new machines within a network. The image references may be stored in a database, such as within data store 168, or in some other location. The images may be stored in one or more shared data stores that are local to the network(s) on which the image will be deployed. According to one aspect, each image includes a virtual machine (VM) role type that specifies the type of VM it can deploy, the number of processors that it should use, the amount of RAM that it will be assigned, a network ID used to find a nearby install point (so the images do not need to be copied repeatedly over the cross datacenter links), and a share path that the deployment code can use to access the VHD.

In some aspects, the machines in the server farms 106 are not upgraded in the traditional manner of downloading data and incorporating the data into the existing software on the machine. Instead, the machines are updated by replacing a VHD with an updated VHD. For example, when a new version of software is needed by a farm, a new farm is deployed that has the new version installed. When the new farm is deployed, the tenants are moved from the old farm to the new farm. In this way, downtime due to an upgrade is minimized and each machine in the farm has a same version that has been tested. When a virtual machine needs to be upgraded, the VM on the machine may be deleted and replaced with the VM that is configured to run the desired service. In some aspects, however, some or all of the servers within the server farms 106 are upgraded using a traditional update procedure that includes an in-place upgrade.

The mapping tables 174 comprise data mapping parameters (e.g., identifiers) that are associated with the server farms 106. For example, at least some aspects store mappings between server farms 106 and tenants. Additionally or alternatively, the mapping tables store mappings between geographic regions and server farms or server farm networks. In this manner, the mapping table can be used to determine an appropriate server farm or server farm network to provide network-based services to a new tenant based on the requested geographic location for the network-based services.

The configuration data 176 contains a map of each of the server farms. For example, the configuration data 176 may include information relating to each of the servers, databases, site collections, and the like of a server farm. The configuration data 176 may include a row for each physical machine, VM, and the like for each of the server farms 106. According to an aspect, each VHD and VM within a server farm has an associated version string. According to an aspect, a configuration file is maintained for each of the server farms that includes the hardware specific settings for the network (e.g., hardware names, IP addresses, etc.). These configuration files may be modified manually or automatically. For example, an authorized user may copy the configuration of a server farm and modify the copy to create a configuration file for another server farm.

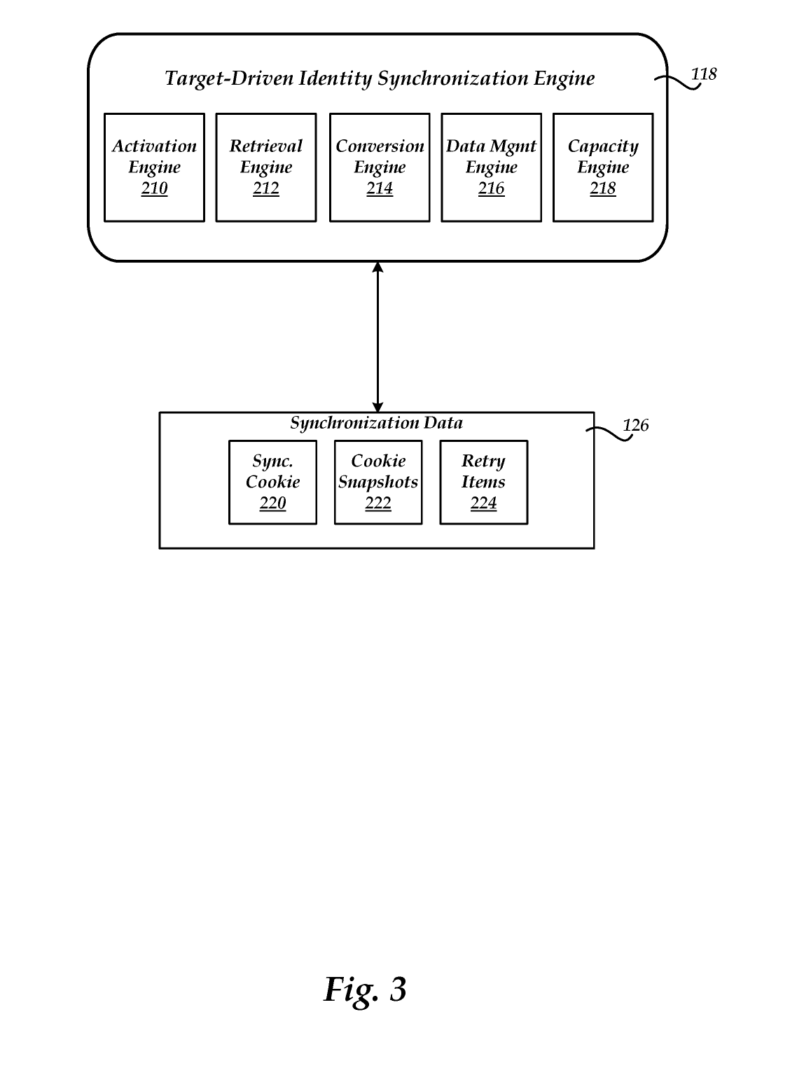

FIG. 3 illustrates example aspects of the target-driven identity synchronization engine 118 and the synchronization data 126. As illustrated, the target-driven identity synchronization engine 118 includes an activation engine 210, a retrieval engine 212, a conversion engine 214, a data management engine 216, and a capacity engine 218. As also illustrated, the synchronization data 126 includes synchronization cookies 220, cookie snapshots 222, and retry items 224.

The activation engine 210 operates to start and perform synchronization operations. In some aspects, the activation engine 210 performs synchronization operations according to a predefined schedule or at predefined intervals (e.g., every minute). At the scheduled time, the activation engine 210 may start or activate a synchronization operation (e.g., by instructing the retrieval engine to retrieve data). The activation engine 210 may start a synchronization operation in response to the occurrence of certain types of events (e.g., a tenant being added or removed from the server farm, completion of a maintenance operation, etc.).

In some aspects, the target-driven identity synchronization engine 118 adjusts the predefined schedule (or intervals) based on how heavily the servers 112 of the server farm are being used. For example, the activation engine 210 may delay a scheduled synchronization operation if the server farm is operating at or near capacity (in terms of processing or data access capacity). Some aspects further limit the duration of a delay due to server farm utilization so that the identity data on the server farm does not have an opportunity to become too out-of-sync with the data from the common identity data repository 104 (e.g., by comparing the delay to a predefine threshold). The activation engine 210 may also determine a data retrieval rate based on the operating conditions of the server farm. For example, if the server farm is currently processing multiple resource-intensive jobs, the determined data retrieval rate may be lower than if the server farm is processing fewer other jobs. The data retrieval rate may be set based on upcoming scheduled job, queued jobs, expected use (e.g., based on historical data), or user input as well. In some aspects, the activation engine does not determine a data retrieval rate if the server farm is not currently being heavily used.

Beneficially, by adjusting the frequency with which synchronization operations are performed, the activation engine 210 can minimize the performance impact to users of the synchronization operations. In contrast, in systems that use an external broker, the broker may not be able to effectively determine when the server farm is being heavily used and thus may not be able to minimize the performance impact to users in this manner. The activation engine 210 may provide other or different benefits as well.

The retrieval engine 212 retrieves identity data from the common identity data repository 104. In some aspects, the retrieval engine 212 transmits a request to the common identity data repository 104 for identity synchronization data. The synchronization data may comprise identity data that is new or has been updated since the retrieval engine 212 last retrieved data from the common identity data repository 104. Some aspects include synchronization state data, such as a synchronization cookie in the request. Upon receiving the request, the common identity data repository 104 may use the synchronization cookie to determine which data should be returned to the retrieval engine 212 in order to synchronize the identity data stored on the server farm. In these aspects, the retrieval engine 212 receives a synchronization cookie (along with identity data) from the common identity data repository 104 in response to a request for identity data. During normal operation, the retrieval engine 212 will then include the most recently received synchronization cookie in requests to the common identity data repository 104. If the server farm has not yet received synchronization data, the retrieval request will not include a synchronization cookie. If an error occurred (or was discovered) on the server farm during (or after) the last synchronization operation, the retrieval engine may transmit an older synchronization cookie (i.e., a synchronization cookie that is not the most recently received synchronization cookie). The retrieval engine 212 may also include additional or different data with requests for identity data. For example, the retrieval engine 212 may include data to identify the server farm 106 (or a corresponding synchronization partition), data to identify the tenants associated with the server farm 106, or other data.

In some aspects, the retrieval engine performs retrieve operations at a rate that is determined based at least in part on the operating conditions of the server farm. For example, the retrieval engine may operate at a slower or faster data transfer rate depending on the current operating conditions of the server farm (e.g., the retrieval engine may specify a data rate in a request for synchronization data or may specify a number of records to retrieve).

The conversion engine 214 operates to convert identity data retrieved from the common identity data repository 104 for storage in the data stores 114. For example, the conversion engine 214 converts data in a format for storage in a directory service to a format for storage in a relational database. The conversion engine 214 may perform other conversions as well. The conversion engine 214 may also execute commands (such as SQL commands) or procedures (such as SQL stored procedures) to store the identity data appropriately in the data stores 114. In some aspects, the conversion engine 214 also stores the received identity data in the format it was received in. For example, if the common identity data repository 104 stores the identity data in a directory service, some aspects maintain a local directory service in the server farm 106.

The data management engine 216 operates to store and manage various data related to the synchronization operations, such as the synchronization data 126. Examples of the data managed by aspects of the data management engine 216 include synchronization cookies 220, cookie snapshots 222, and retry items 224. The synchronization data 126 may be stored in one or more databases, file systems, or combinations thereof.

The synchronization cookies 220 comprise one or more files or data structures for use in coordinating synchronization operations with the common identity data repository 104. As described above, the synchronization cookie is provided by the common identity data repository 104 in response to requests for identity data and is usable by the common identity data repository 104 to determine which identity data to return to the target-driven identity synchronization engine 118. In aspects, the synchronization cookies 220 include a time stamp, transaction identifier, or other data usable to determine the data that has changed since the last synchronization operation.

The cookie snapshots 222 comprise a plurality of historical synchronization cookies. The historical synchronization cookies are usable to retrieve and synchronize identity data in the event of an error on the server farm 106 that occurred (or was discovered) during or after the most recent synchronization operation. In this manner, the cookie snapshots 222 can be used to recover from errors and resynchronize identity data from the time of a selected historical synchronization cookie. Generally, the older a synchronization cookie is, the more identity data will be returned in response to a request that includes the synchronization cookie (e.g., because the identity data has had more time to change since the synchronization cookie was generated). The data management engine 216 may save historical synchronization cookies intermittently with the duration between saved synchronization cookies growing approximately exponentially (i.e., the duration of time between older historical synchronization cookies is greater than newer historical synchronization cookies). An example of the cookie snapshots comprises historical synchronization cookies that are approximately 2 minutes old, 6 minutes old, 20 minutes old, 60 minutes old, etc. Depending on when the detected error occurred, a historical synchronization cookie can be retrieved from the cookie snapshots 222 that was received before the error. The more recently the error occurred, the more closely the age of the historical synchronization cookie can be matched to the error. In this manner, the data management engine 216 balances error recovery needs against minimizing the amount of storage required for synchronization cookies.

The retry items 224 comprise identity data received in response to a synchronization operation that could not be fully added to the tenant data 120, user data 122, or other location in the data stores 114. For example, while a synchronization operation is in process, a partial record relating to a user may be received. If this example partial record does not include all of the information required to add a record to the user data 122, then the partial information is stored in the retry items 224 until the remainder of the information is received.

The capacity engine 218 operates to determine the current capacity of the server farm to receive new tenants. In some aspects, the capacity engine 218 determines a weight value based on the available capacity of the server farm. As described above, the weights may be determined based on a number of factors including the current workload of the server farm, the identity data storage capacity of the server farm, the service or document storage capacity of the server farm, the operational status of the server farm (e.g., whether the server farm is running, blocked, in maintenance), and other factors. Alternatively or additionally, the weight is determined based on an input from a user such as an administrator. The weights may change over time due to changes in workload, status, and the number of or configuration of servers in the server farm. The capacity engine 218 may operate to calculate a weight value for a server farm repeatedly according to a predefined schedule or in response to the occurrence of particular events (e.g., returning from maintenance mode). In aspects, the weight value is stored locally in the data store of the server farm and is used by the synchronization engine to determine whether to accept new tenants. Additionally or alternatively, the capacity engine may transmit the determined weight value to the network-based services manager 102 for use in allocating tenants to server farms.

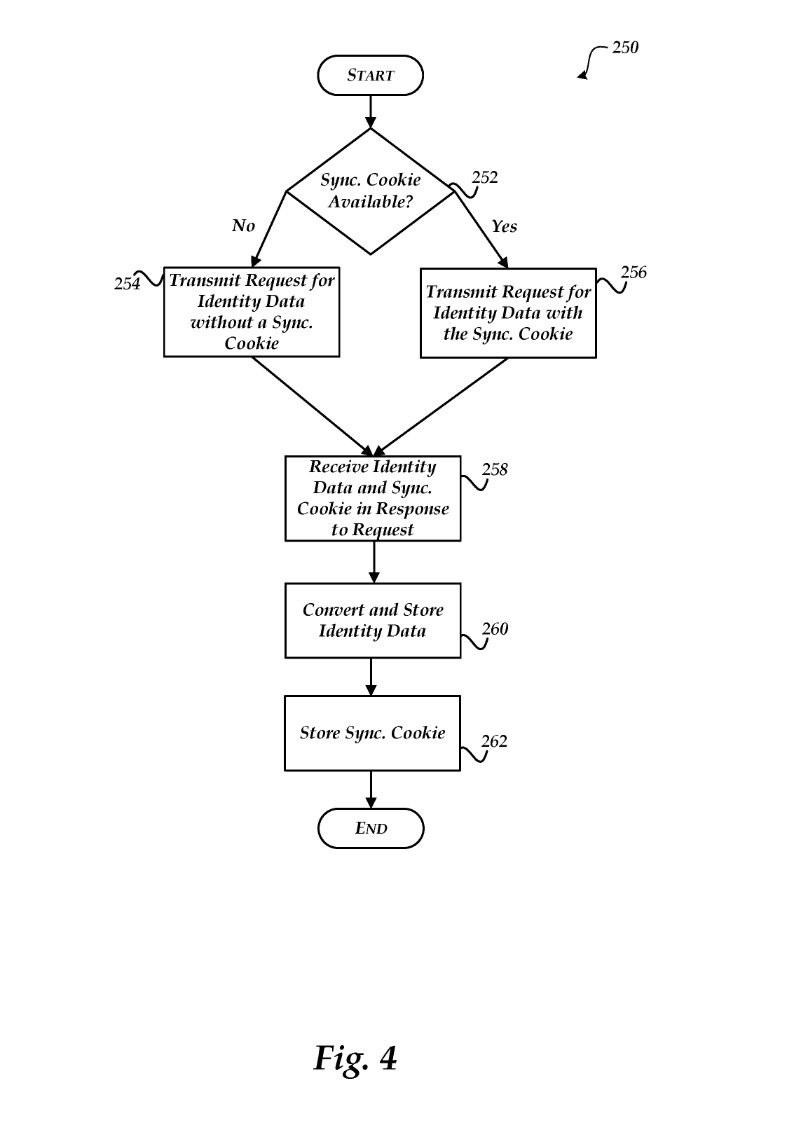

FIG. 4 illustrates an exemplary method 250 for performing a synchronization operation. The method 250 may be executed by a component of an exemplary system such as the system 100. For example, the method 250 may be performed by the target-driven identity synchronization engine 118. The method 250 may be executed on a device comprising at least one processor configured to store and execute operations, programs, or instructions.

At operation 252, it is determined whether a synchronization cookie is available. As described above, synchronization cookies are typically received from the common identity data repository 104 along with identity data. Determining whether a synchronization cookie is available may comprise querying a database or accessing a cookie file stored in a file system. If it is determined that a synchronization cookie is not available, the method 250 proceeds to operation 254. Otherwise, the method 250 proceeds to operation 256.

At operation 254, a request for identity data is transmitted without a synchronization cookie. While at operation 256, a request for identity data is transmitted with a synchronization cookie. Generally, the requests are transmitted to the common identity data repository 104.

At operation 258, identity data and a synchronization cookie are received in response to the requests issued in operations 254 or 256. The identity data and synchronization cookie are generally received from the common identity data repository 104.

At operation 260, the received identity data is converted, if necessary, to a format for storage in the data stores 114. Additionally at operation 260, the received identity data is stored in the data stores 114. Storing the received identity data may comprise adding new records or updating existing records in the data stores 114.

At operation 262, the received synchronization cookie is stored for use during the next synchronization operation. For example, the received synchronization cookie may be stored in the data stores 114. In some aspects, when the received synchronization cookie is stored in the data stores, one or more synchronization cookies that have been previously stored in the data stores are removed, archived, or identified as a historical cookie in the cookie snapshots. The cookie snapshots may be used to recover from an error by synchronizing based on one of the historical cookie. As described previously, a subset of the synchronization cookies may be retained as historical cookies to allow recovery from various historical states.

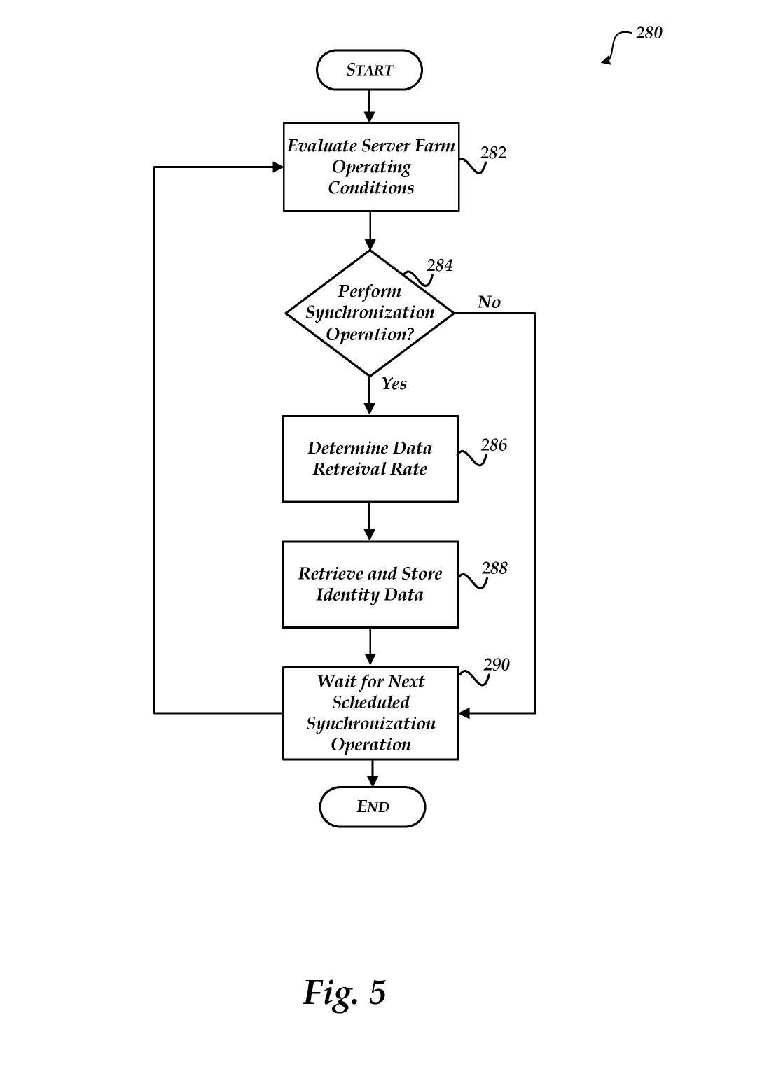

FIG. 5 illustrates an exemplary method 280 for determining whether to perform a synchronization operation. The method 280 may be executed by a component of an exemplary system such as the system 100. For example, the method 280 may be performed by the target-driven identity synchronization engine 118. The method 280 may be executed on a device comprising at least one processor configured to store and execute operations, programs, or instructions.

At operation 282, the server farm operating conditions are evaluated. In some aspects, evaluating the server farm operating conditions comprises evaluating the current workload of the server farm and the current status of the server farm.

At operation 284, it is determined whether to perform a synchronization operation. In some aspects, the determination of whether to perform a synchronization operation is based on the evaluation of the operating conditions performed at operation 282. For example, if the current workload is high (e.g., above a predefined threshold level of system, processor, or memory use) or if a job queue for the server farm exceeds a predetermined number of jobs, it is determined not to perform the synchronization operation. However, even when the current workload is high, in some aspects, the synchronization operation will be performed if more than a predefined duration of time has elapsed since the preceding synchronization operation. Additionally, if the server farm status indicates it is stopped or down for maintenance, it is determined not to perform a synchronization operation. If it is determined to perform a synchronization operation, the method 280 proceeds to operation 286. If not, the method 280 proceeds to operation 290.

At operation 286, a data retrieval rate is determined. The data retrieval rate may be determined based on the operating conditions of the server farms. For example, the data retrieval rate may be determined based on similar factors to those discussed above with respect to determining whether to perform the synchronization operation. In some aspects, the data retrieval rate may be set to indicate that a cap on data retrieval is unnecessary (e.g., when the server farm has sufficient resources available to perform the synchronization job without impacting other higher priority jobs).

At operation 288, identity data is retrieved from the common identity data repository 104 and stored in the data stores 114. Examples of retrieving and storing identity data have been illustrated and described previously at least with respect to FIG. 4.

At operation 290, the method 280 waits for the next scheduled synchronization operation. As described above, synchronization operations may occur according to a predefined schedule or at regular intervals.

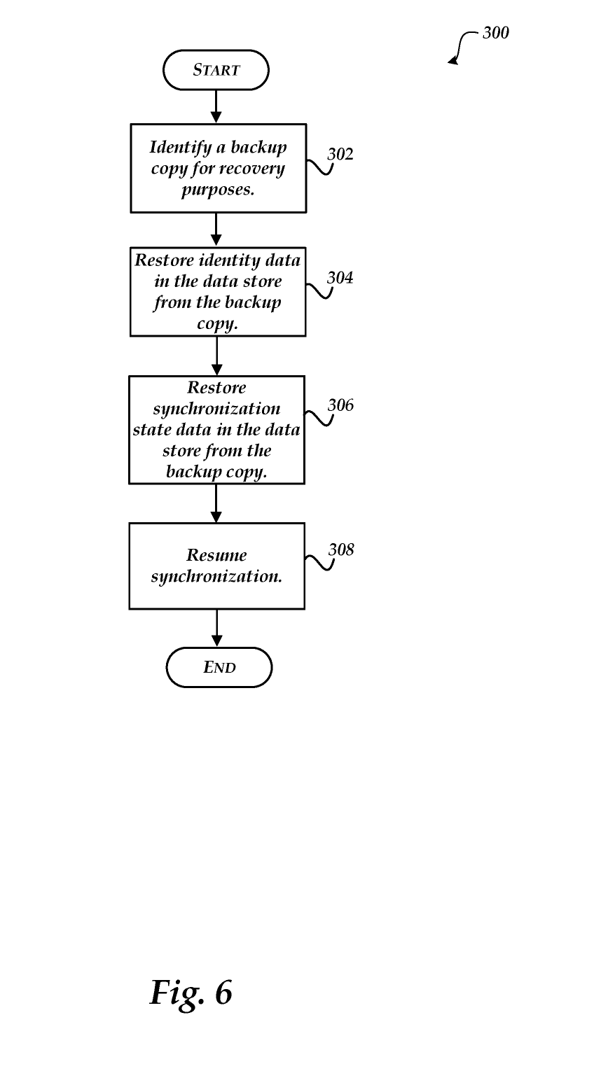

FIG. 6 illustrates an exemplary method 300 for recovering a server farm and restoring synchronization. For example, the method 300 may performed as part of a disaster recovery process to restore operation of a server farm after a disaster or another event takes the server farm off line. The method 300 may be executed by a component of an exemplary system such as the system 100. The method 300 may be executed on a device comprising at least one processor configured to store and execute operations, programs, or instructions.

At operation 302, a previously made backup copy of the data store of a server farm is identified for recovery purposes. The backup copy may include a portion of the contents of the data store or the entire contents of the data store. The backup copy may have been made and stored using any type of data backup/recovery technology. In some aspects, a backup copy that was made before a particular event (e.g., the disaster or other type of event for which the recovery was required) is identified and used to recover the identity data.

At operation 304, the identity data in the data store of the server farm is restored from the identified backup copy. Recovering the identity data may comprise replace a portion of a database or filesystem with the backup copy. Similarly, at operation 306, the synchronization state data in the data store of the server farm is restored from the identified back copy. In fact, the synchronization state data may be recovered simultaneously with the identity data (e.g., when an entire database or file system is restored using the identified backup copy).

At operation 308, synchronization resumes using the recovered synchronization state data. An example synchronization process is illustrated and described with respect to at least FIG. 4. Beneficially, when the identity data and synchronization state data of the server farm are restored from the same backup copy, the identity data can be correctly synchronized with the common identity data repository. For example, the restored synchronization cookie, cookie snapshots, and retry items all correspond to the restored identity data. Thus, when the recovered synchronization cookie is included in a request for identity data that is sent to the common identity data repository 104, the common identity data repository 104 will be able to identify the identity data that has been added/updated since the backup copy was made.

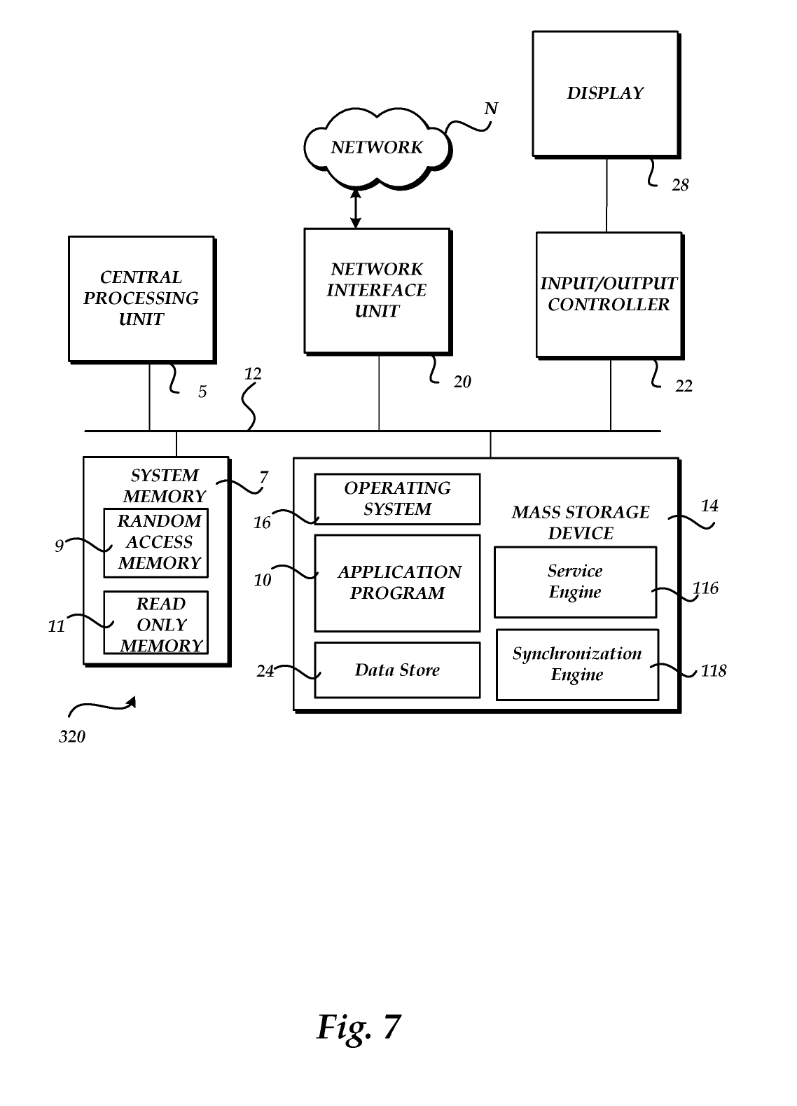

Referring now to FIG. 7, an illustrative computer architecture for a computer 320 utilized in the various aspects will be described. The computer architecture shown in FIG. 7 may be configured as a server, a desktop, or a mobile computer and includes a central processing unit 5 (“CPU”), a system memory 7, including a random access memory 9 (“RAM”) and a read-only memory (“ROM”) 11, and a system bus 12 that couples the system memory 7 to the CPU 5. The computer 320 is an example of the servers 112 of the server farms 106.

A basic input/output system containing the basic routines that help to transfer information between elements within the computer, such as during startup, is stored in the ROM 11. The computer 320 further includes a mass storage device 14 for storing an operating system 16, application programs 10, data store 24, files, and a service engine 116 relating to execution of and interaction with the system 100.

The mass storage device 14 is connected to the CPU 5 through a mass storage controller (not shown) connected to the bus 12. The mass storage device 14 and its associated computer-readable media provide non-volatile storage for the computer 320. Although the description of computer-readable media contained herein refers to a mass storage device, such as a hard disk or CD-ROM drive, the computer-readable media can be any available media that can be accessed by the computer 320.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 320. Computer storage media does not include a carrier wave or other propagated or modulated data signal.

According to various aspects, computer 320 may operate in a networked environment using logical connections to remote computers through the network N, such as the Internet. The computer 320 may connect to the network N through a network interface unit 20 connected to the bus 12. The network interface unit 20 may connect over a wireless or wired network. The network interface unit 20 may also be utilized to connect to other types of networks and remote computer systems. The computer 320 may also include an input/output controller 22 for receiving and processing input from a number of other devices, including a keyboard, mouse, or electronic stylus (not shown in FIG. 7). Similarly, an input/output controller 22 may provide output to a display screen 28, a printer, or other type of output device.

As mentioned briefly above, a number of program modules and data files may be stored in the mass storage device 14 and RAM 9 of the computer 320, including an operating system 16 suitable for controlling the operation of a networked computer, such as the WINDOWS® operating systems from MICROSOFT® CORPORATION of Redmond, Wash. The mass storage device 14 and RAM 9 may also store one or more program modules. In particular, the mass storage device 14 and the RAM 9 may store one or more application programs, such as the service engine 116 or the target-driven identity synchronization engine 118, which have both been previously described.

Reference has been made throughout this specification to “one example,” “an example,” or “an aspect,” meaning that a particular described feature, structure, or characteristic is included in at least one example or aspect. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to avoid obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A server farm for providing network-based services, comprising:
a plurality of server computing devices;
a data store operable to store data for the server farm;
a service engine running on at least one of the plurality of server computing devices, the service engine configured to provide network-based services; and
a synchronization engine running on a server computing device of the plurality of server computing devices, the synchronization engine configured to synchronize identity data from a common identity data repository to the data store and to manage synchronization state data stored in the data store.

2. The server farm of claim 1, wherein the synchronization engine further comprises:
an activation engine configured to determine when to activate synchronization operations;
a retrieval engine configured to retrieve identity data from the common identity data repository; and
a data management engine configured to manage synchronization data.

3. The server farm of claim 2, wherein the retrieval engine is further configured to determine a data retrieval rate and wherein the retrieval engine is configured to retrieve identity data from the common identity data repository at the determined data retrieval rate.

4. The server farm of claim 2, wherein the activation engine is configured to determine when to activate synchronization operations by being configured to:
calculate a duration of time since a preceding synchronization operation completed;
compare the duration to a predefined time interval; and
when the duration exceeds the predefined time interval:
evaluate operating conditions of the server farm; and
determine whether to perform a synchronization operation based on the operating conditions of the server farm.

5. The server farm of claim 2, wherein the retrieval engine is configured to retrieve identity data from the common identity data repository by being configured to:
transmit a request for identity data to the common identity data repository; and
receive identity data in response to the transmitted request.

6. The server farm of claim 5, wherein the data management engine is configured to manage synchronization data by being configured to store, in the data store of the server farm, a synchronization cookie received in response to the request for identity data, the synchronization cookie usable by the common identity data repository to identify identity data that requires synchronization.

7. The server farm of claim 6, wherein the retrieval engine is configured to include a synchronization cookie stored in the data store of the server farm with the request for identity data.

8. The server farm of claim 5, wherein the synchronization engine is further configured to store received identity data in the data store and wherein the synchronization engine further comprises a conversion engine configured to convert the received identity data to a format for storage in the data store, wherein the format is associated with the network-based services provided by the service engine.

9. The server farm of claim 1, further comprising a capacity engine configured to determine a weight value for the server farm based on evaluating at least one of:
the available capacity of the server farm; and
the operational status of the server farm.

10. A computer-implemented method for synchronizing identity data from a common identity data repository to a server farm, comprising:
evaluating, by a synchronization engine running on a server computing device of the server farm, the operating conditions of the server farm;
determining whether to perform a synchronization operation based on the operating conditions of the server farm; and
when determined to perform a synchronization operation:
retrieving identity data;
storing the identity data; and
storing synchronization state data in a data store of the server farm based on the synchronization operation.

11. The computer-implemented method of claim 10, wherein retrieving identity data comprises:
transmitting a request for identity data to the common identity data repository; and
receiving identity data in response to the transmitted request.

12. The computer-implemented method of claim 11, wherein retrieving identity data further comprises:
receiving a synchronization cookie usable by the common identity data repository to identify identity data that requires synchronization.

13. The computer-implemented method of claim 12, wherein storing synchronization state data comprises storing the received synchronization cookie in a data store of the server farm.

14. The computer-implemented method of claim 13, wherein the request for identity data includes a synchronization cookie that was previously stored in the data store of the server farm.

15. The computer-implemented method of claim 10, wherein evaluating the operating conditions of the server farm comprises determining the current workload of the server farm; and
wherein determining whether to perform the synchronization operation comprises:
comparing the current workload of the server farm to a predefined threshold value; and
when the current workload exceeds the predefined threshold value, determining not to perform the synchronization operation.

16. The computer-implemented method of claim 10, wherein evaluating the operating conditions of the server farm comprises determining the operational status and determining the number of queued jobs in a job queue for the server farm; and
wherein determining whether to perform the synchronization operation comprises:
comparing the number of queued jobs to a predefined threshold value; and
when the number of queued jobs exceeds the predefined threshold value, determining not to perform the synchronization operation.

17. The computer-implemented method of claim 10, further comprising:
when determined to perform the synchronization operation determining a data retrieval rate for the synchronization operation based on the operation conditions of the server farm.

18. The computer-implemented method of claim 10, wherein the common identity data repository comprises a directory service and storing the identity data comprises updating a relational database on the server farm based on the identity data.

19. The computer-implemented method of claim 10, wherein the common identity data repository is configured to store identity data for multiple server farms, the identity data being associated with a plurality of tenants.

20. A synchronization engine configured to run on a server computing device of a server farm and operable to synchronize identity data between a common identity data repository configured to store identity data for a plurality of server farms with a data store of the server farm, the synchronization engine comprising:
an activation engine configured to:
calculate a duration of time since a preceding synchronization operation completed;
compare the duration to a predefined time interval; and
when the duration exceeds the predefined time interval:
evaluate operating conditions of the server farm; and
determine whether to perform a synchronization operation based on the operating conditions of the server farm;
a retrieval engine configured to:
transmit a request for identity data to the common identity data repository; and
receive identity data in response to the transmitted request; and
a data management engine configured to store, in the data store of the server farm, a synchronization cookie received in response to the request for identity data, the synchronization cookie usable by the common identity data repository to identify identity data that requires synchronization.
